(19) United States
(12) Patent Application Publication
(10) Pub. No.: US 2025/0114995 A1
(43) Pub. Date: Apr. 10, 2025

(54) A FILM COMPOSITION

(71) Applicant: HUHTAMAKI INDIA LIMITED, Bandra (East) Mumbai, Maharashtra (IN)

(72) Inventors: Ashwini Kumar SINGH, Bandra (East) Mumbai (IN); Uma Shankar (Deceased) GUPTA, Bandra (East) Mumbai (IN)

(21) Appl. No.: 18/834,829

(22) PCT Filed: Nov. 18, 2022
(86) PCT No.: PCT/IN2022/051014

§ 371 Date: Jul. 31, 2024

(30) Foreign Application Priority Data
Jan. 31, 2022 (IN) 202221005297

(51) Int. Cl. B29C 48/00; B29C 37/00; B29C 48/09; B29C 48/21; B29C 48/36; B29K 23/00

(52) U.S. Cl. CPC B29C 48/022; B29C 37/0025; B29C 48/0017; B29C 48/0019; B29C 48/09; B29C 48/21; B29C 48/36; B29K 2023/0625; B29K 2023/0633; B29K 2023/0641; B29K 2023/065; B29K 2023/08; B29K 2023/086; B29K 2995/0072

(57) ABSTRACT

A film composition including acid copolymer in a range of 1 to 10%, metallocene Linear low-density polyethylene (LLDPE) in a range of 5 to 15%, low density polyethylene (LDPE) in a range of 5 to 10%, anti-block masterbatch in the range of 0.5 to 1%, high density polyethylene (HDPE) in a range of 20 to 50%, plastomer in a range of 5 to 30% and slip additive in a range of 0.5 to 1%. Also disclosed is a film made from the film composition and to a laminate made from the film.

### FIELD OF THE INVENTION

The invention relates to a film composition. More particularly, the invention relates to a film composition with superior barrier properties and to a laminate made therefrom, for wide range of packaging applications. The present application likewise refers to a barrier film which is in particular suitable to be used to form a packaging material, for example a multi-layer structure as a basis to form a flexible packaging. The present application further refers to a multi-layer structure containing a barrier film, and to flexible packaging formed out of the multi-layer structure.

### BACKGROUND OF THE INVENTION

Flexible packaging solutions find application in beverage, food, consumer packaged goods, personal care products, etc., and with rising consumer needs and requirements, flexible packaging solutions continue to evolve. Flexible laminates used for packaging are generally tailormade based on the needs of the products that are packaged. While barrier properties, durability, etc. remain essential requirements for flexible packaging solutions, retaining product characteristics such as aroma, crispness etc. are equally important. Different types of laminates are used in the industry depending on the product, its environment of storage, geography of usage, pack sizes etc.

A packaging material is either a single layer film or made from at least 2 layers, wherein each layer requires inherent key characteristics to perform its role. Typically, a laminate having barrier properties comprises of at least two or three layers/substrates—Printing Substrate, Barrier substrate and/or Sealant substrate. Depending on the barrier requirement of the product to be packed, the laminate can have a dedicated barrier layer or can contain films which have barrier which is sufficient for product protection. The most commonly used barrier substrates in flexible packaging are metallized PET, metallized BOPP, aluminum foil, biaxially oriented poly amide (also called as BOPA, Polyamide), metallized CPP etc. Polyethylene films in flexible packaging are mostly used as sealant substrates, with a few notable exceptions like when they contain EVOH and are then also used as barrier films for specific product such as cheese, red meat etc. However, such usage of polyethylene as a barrier are more the exception than the norm.

While the utility of polyethylene films as sealants is long established, they lack barrier properties which is a drawback for packaging applications as it requires their use with other additional barrier films (as detailed above) films pushing up the overall laminate thickness, complexity and hence cost. In other words, a high barrier laminate design in the industry is normally of at least three layers (called “three ply” in industry parlance), where the polyethylene film is used as a sealant and other films fulfil the use of additional requirements such as printing and barrier etc. In few cases a 2ply laminate can also be used as ‘low or medium’ barrier laminate which typically consists of PET or BOPP films as print film laminated to polyethylene film containing EVOH. There are other examples of 2 ply laminates being used for packaging for low/medium barrier product requirements, e.g. BOPP/BOPP for biscuits, BOPP/MetBOPP for biscuits, confectionary, BOPP/METCPP for snacks etc. However, all these laminates are typically categorised as low/medium barrier 2ply laminates and the ones which are required for critical product applications (e.g. Coffee, Yeast, Dry Soup Powder, Infant Formula etc to name just a few) are all necessarily 3ply laminates containing specifically designed barrier films like aluminium foil, metallized PET, metallized BOPP etc, as explained hereinbefore.

The barrier property is essentially the property of materials to restrict passage of gas or vapor through them. The barrier requirement (higher or lower) from a laminate is determined mainly by the nature of product that is getting packed, size of the pack & intended shelf life after packing. The more sensitive the product (hygroscopic, oxygen, moisture sensitivity), the higher is the barrier requirement of laminate and vice-a-versa.

In order to determine the barrier requirement and to ascertain barrier property, two properties are commonly used Moisture Vapor Transfer Rate—MVTR—Measured in Grams/m²/day—at 38° C. & 90% RH and Oxygen Transfer Rate—OTR—Measured in CC/m²/day—at 23° C. & 0-50%% RH.

Material source reduction and recyclability is also a continual goal of the flexible packaging industry. But there is a compromise in barrier properties as well as the strength in the film when reducing the thickness of the laminate.

Accordingly, there is a need for a laminate that achieves the desired barrier protection, heat seal ability, and desired printing properties at lower thicknesses which can at the same time be utilized as packaging for different products with specific characteristics.

### SUMMARY OF THE INVENTION

In one aspect the present invention provides a film composition comprising acid copolymer in a range of 1 to 10%, metallocene Linear low density polyethylene (LLDPE) in a range of 5 to 15%, low density polyethylene (LDPE) in a range of 5 to 10%, anti-block masterbatch in the range of 0.5 to 1%, high density polyethylene (HDPE) in a range of 20 to 50%, plastomer in a range of 5 to 30% and slip additive in a range of 0.5 to 1%.

In another aspect, the present invention provides a film formed or produced with the film composition, wherein the film may be metallized or non-metallized.

In another aspect, the present invention provides a laminate, comprising a first film; and a second film bonded with the first film, the second film comprising a film, either metallized or non-metallized with a composition of acid copolymer in a range of 1 to 10%, metallocene Linear low density polyethylene (LLDPE) in a range of 5 to 15%, low density polyethylene (LDPE) in a range of 5 to 10%, anti-block masterbatch in the range of 0.5 to 1%, high density polyethylene (HDPE) in a range of 20 to 50%, plastomer in a range of 5 to 30% and slip additive in a range of 0.5 to 1%.

In other words and viewed from a different angle, the present application refers to a barrier film which is in particular suitable to be used to form a packaging material, for example a multi-layer structure as a basis to form a flexible packaging. The barrier film comprises a polymer carrier layer. The carrier layer bears on at least one of its surfaces a deposited deposition layer of a metal-based material. The polymer of the carrier layer contains a linear ethylene-based polymer.

Such a barrier film having a polymer carrier layer with a metal-based deposition layer deposited on at least one of its surfaces is in widespread use in the packaging industry and can be found in many multi-layer materials suitable and intended to form flexible packagings, like pouches, flow-packs and the like.

A barrier film of the above generic kind as part of a multi-layer structure is for example known from WO 2014/209411 A1. This document discloses an attempt to increase the otherwise generally poor bonding strength between a polyethylene substrate or carrier layer and a metallized film applied onto the substrate layer. WO 2014/209411 A1 teaches to increase the bonding strength by forming the carrier layer to at least 50 weight-% out of an ethylene/alpha-interpolymer with a Comonomer Distribution Constant in a particular value range.

The material of the carrier layer of this barrier film is rather difficult to compose.

The metal-based deposition layer significantly decreases the permeability of the barrier film by oxygen and water vapor, in the prior art also often referred to as “moisture”, compared to the carrier layer alone. The metal-based deposition layer thereby contributes largely to extending the shelf life of a packaged product which would otherwise oxidize earlier and/or would accumulate moisture and soften, and in the end perish earlier. Therefore, barrier films of the generic type are used in packaging for foodstuff products and other perishable goods.

Apart from its oxygen and water vapor barrier properties, which are the focus of the present invention, metal-based deposition layers can, depending on the individual deposited material, provide a metal-like outer appearance and enhance the aesthetic appeal of a packaging, when visible from the outside.

Moreover, again depending on the individual deposited material, a metal-based deposition layer can render the deposition layer electrically conductive and can therefore provide a Faraday cage in a packaging and thereby shield a packaged object from electrical fields outside the packaging.

By the same token an electrically conductive deposition layer exposed to the inside of a flexible packaging surrounding a packaging volume can serve to level out electric potentials on packaged products. It can thereby protect sensitive electronic components accommodated in the packaging volume.

Before depositing metal-based materials on polymer carrier layers was more and more used, aluminum foils were laminated to polymer films, in order to provide a layer arrangement with enhanced oxygen and water vapor barrier properties. However, aluminum foils are no longer preferred due to the heavy use of resources related to the provision of an aluminum foil and further due to the resulting complexity of recycling processes of laminates containing aluminum foils after their use.

In contrast to laminated aluminum foils deposited metal-based deposition layers are much thinner. Often aluminum foils in flexible packaging laminates are thicker by a factor of 20 to 50 than deposition layers used in flexible packaging films.

Such a delicate deposition layer, which is expected to reliably provide its barrier effects to the polymer carrier layer onto which it is deposited, is susceptible to any undesired influences that may occur during or after production of the barrier film.

It is therefore the object of the present invention, to provide a barrier film of the generic kind as set forth at the beginning of this application with a reliable and durable metal-based deposition layer that provides a strong oxygen and water vapor barrier property to the barrier film over a long period of time.

The present invention attains this object in that the polymer of the carrier layer comprises a blend of low density polyethylene, a linear ethylene-based polymer and at least one receptor component selected from
i) a terpolymer of ethylene, acrylic acid, and acrylate, and
ii) an ethylene-based alpha-copolymer grafted with a polar group.

For example, the receptor component of above type i) can be a polymer available by the tradename “Nucrel™ AE”, distributed by The Dow Chemical Company Global Dow Center, 2211 H. H. Dow Way, Midland, Michigan 48674 (US) and its affiliates. A possible receptor component of above type ii) is a polymer available by the trade-name “Tafmer™ MA 9015”, distributed by Mitsui Chemicals, Inc., Shiodome City Center, 5-2, Higashi-Shimbashi 1-chome, Minato-ku, Tokyo 105-7122 and its affiliates. Corresponding receptor materials from other suppliers are of course also possible.

The inventors could show in laboratory results that the combination of ingredients to form the basic composition of the polymer carrier layer, which is predominantly a polyethylene layer, tremendously increases the bonding strength between the metal-based deposition layer and the carrier layer. The bonding strength between the metal-based deposition layer and the carrier layer amounts to a peel strength of at least 2 N per 15 mm, measured according to AIMCAL-TP-105-92.

The deposition layer can be manufactured by any known vapor deposition process, for example by physical vapor deposition or by chemical vapor deposition. In order to avoid any unintended and undesired chemical loads to the carrier layer physical vapor deposition of the metal-based material is preferred.

A metal-based material can be any material to which a metal contributes. Hence, the metal-based material of the deposition layer comprises at least one of a metal and a metal-oxide. As a metal aluminum is preferred, but any metal can be vapor deposited the carrier layer, for example gold or silver or alloys containing silver or aluminum. The deposition of metal, i. e. metallization, can provide a shining metallic appearance to the barrier film on the side of the deposition layer.

Barrier properties can also be enormously enhanced by depositing metal-oxide on the surface of the carrier layer. Here, aluminum oxide (generally AlOx, in particular Al₂O₃) or silicon oxide (generally SiOx) is preferred. Such deposition layers made of metal-oxides are usually transparent and do not or only hardly affect the visual appearance of the barrier film when looking at its deposition layer.

When metal is deposited to the carrier layer it is preferably deposited to an optical density of at least 2.2, preferably of at least 2.6, optionally of even at least 2.8.

The linear ethylene-based polymer comprises at least one of a linear low density polyethylene and a linear ethylene-octene copolymer, in particular ethylene-1-octene-copolymer. Experiments have shown that by the use of these linear ethylene-based polymers the largest bonding strengths between the metal-based deposition layer and the carrier layer can be achieved.

The further increase in the bonding strength between the deposition layer and the carrier layer can be achieved by using a metallocene linear ethylene-based polymer as a component of the linear ethylene-based polymer or as the linear ethylene-based polymer as such. Therefore the linear ethylene-based polymer comprises a metallocene linear ethylene-based polymer or consists of a metallocene linear ethylene-based polymer.

When used in the present application, the term “polymer” covers every possible kind of polymerized material, such as a homopolymer, a copolymer, a terpolymer and so forth, irrespective of the number of different monomers used to form the polymer. In contrast thereto, the term “copolymer” designates a polymer of two different mono-mers, the term “terpolymer” designates a polymer of three different monomers and so forth.

With regard to the ratios of the individual components that mandatorily have to be present in the polymer of the carrier layer,
i) the weight proportion of the receptor component in the total weight of the polymer carrier layer ranges between 26 to 34 weight-%,
ii) the weight proportion of the linear ethylene-based polymer in the total weight of the polymer carrier layer ranges between 44 to 46 weight-%, and
iii) the weight proportion of the low density polyethylene in the total weight of the polymer carrier layer ranges between 15 to 21 weight-%.

The polymer of the polymer carrier layer represents 100 weight-%. That means the sum of the weight percentages of the receptor component, the linear ethylene-based polymer and the low density polyethylene does not exceed 100, but may be less, if further components contribute to the formation of the carrier layer polymer.

A blend of the receptor component, the linear ethylene-based polymer and the low density polyethylene is usually tacky and may therefore be difficult, but not impossible, to process on the available machinery. In order to facilitate machine processing of the polymer of the carrier layer and hence of the carrier layer, the polymer of the carrier layer preferably comprises an antiblocking agent. The antiblocking agent contributes to the weight of the polymer of the polymer carrier layer.

Basically, the antiblocking agent can be any known and established antiblocking agent. A preferably useful antiblocking agent comprises or consists of a mineral silica compounded in polyethylene. Being compounded in polyethylene the antiblocking agent is easy to blend into the remaining polymer of the carrier layer.

The share or weight proportion of the antiblocking agent in the total weight of the polymer carrier layer may preferably range between 1.4 to 2.6 weight-%, so that it has an antiblocking effect without affecting other properties of the carrier layer.

Preferably, the polymer carrier layer is a blown film. It may be blown as a single layer or as the outermost, exposed layer of a multi-layer film. Preferably the entire multi-layer film can be produced as a blown film. Nonetheless, it may as well be produced partly or entirely as a extrusion-laminated multi-layer film.

The polymer carrier layer can contain the above components and may contain further additional components as desired, for example a dying agent or colored pigments. Since the carrier layer in practical use will only be one of several polymer layers of a packaging multi-layer film, a preferred embodiment of the polymer carrier consists of a blend of
i) low density polyethylene;
ii) a linear ethylene-based polymer;
iii) a terpolymer of ethylene, acrylic acid, and acrylate; and
iv) an antiblocking agent, as mentioned above.

The barrier film as explained and refined above usually only is a crucial or one of several crucial components of an entire packaging multi-layer film.

The present invention therefore further refers to a multi-layer film comprising the barrier film as described and refined above and further comprising at least one additional layer selected from a layer group containing at least the following layer types:
a) a bulk layer,
b) a sealable layer,
c) an oxygen barrier layer,
d) a water vapor barrier layer, and
e) a tie layer,
   wherein the multi-layer film may comprise more than one layer of the same layer type. Therefore, the multi-layer film may contain two or more bulk layers, if so desired. Usually one sealable layer is sufficient, although it may not be excluded, that the multi-layer film can be designed to be sealable on both its exposed outermost surfaces. Additional barrier layers can further enhance the barrier properties of the entire laminate.

The multi-layer film is preferably a blown multi-layer film. It may, however, be partly or entirely be formed by extrusion-lamination.

An oxygen barrier layer in the meaning of the present application is layer of a material that has a particularly below-average oxygen transfer rate. Oxygen transfer rates according to the present invention are to be measured according to ASTM D 3985 with the test environment atmosphere being conditioned to 23° C. and a relative humidity of 0%, i. e. a dry atmosphere. For determining the oxygen transfer rate under humid conditions in environment atmosphere of 23° C. and a relative humidity of 50% measurements are conducted according to ASTM F1927.

A layer is an oxygen barrier layer, if it has an oxygen transfer rate of 75% or less of an equally thick LLDPE reference layer, when measured according to the above-captioned measurement standards.

A water vapor barrier layer in the meaning of the present application is a layer of a material that has a particularly below-average water vapor transfer rate. Water vapor transfer rates according to the present invention are to be measured according to ASTM F1249 with a tropical test environment atmosphere being conditioned to 38° C. and a relative humidity of 90%.

A layer is a water vapor barrier layer, if it has a water vapor transfer rate of 75% or less of an equally thick LLDPE reference layer, when measured according to the above-captioned measurement standard.

An oxygen barrier layer can be formed for example out of a vinyl alcohol polymer, in particular out of ethylene vinyl alcohol copolymer or out of polyvinyl alcohol, wherein ethylene vinyl alcohol copolymer is preferred as it is ethylene-based like the components of the carrier layer which renders the carrier layer and the oxygen barrier layer out of EVOH advantageously recyclable in one single recycling stream. A vinyl-alcohol-polymer oxygen barrier layer, be it based on ethylene or on polyvinyl, has preferably a share of the total weight of the packaging multi-layer film of between 5 to 12 weight-%, more preferably of between 6 to 10 weight-%: particularly preferably of between 7.5 to 8.5 weight-%.

The bulk layer may be arranged in immediate neighborhood of the carrier layer, on either side of the carrier layer, i. e. on the side of the deposition layer and on the opposite side, where preferably no deposition layer is deposited on the carrier layer.

Although the carrier layer may bear a deposition layer on both its outermost surfaces, preferably a deposition layer is deposited on only one of the surfaces of the carrier layer. Preferably the surface of the carrier layer on which the deposition layer is deposited is closer to the outside, i. e. directed towards a possible consumer, in a flexible packaging formed of a multi-layer film containing the barrier film explained and refined above.

The bulk layer may be formed of any suitable polymer, like for example polyethylene terephthalate (PET), polyamide (PA), in particular by axially oriented polyamide (BOPA), polypropylene (PP), in particular biaxially oriented polyethylene (BOPP), and polyethylene (PE), in particular machine direction oriented polyethylene (MDO-PE), particularly preferred medium density polyethylene (MDPE) or high density polyethylene (HDPE), to provide stability and structure to the multi-layer film. A high density polyethylene layer is provided as a bulk layer since HDPE provides not only mechanical stability, but also a substantial oxygen and, to a slightly lower extent, a water vapor barrier.

According to a preferred solution, a bulk layer can be formed of a blend of HDPE and linear low density polyethylene (LLDPE), in order to enhance the bonding strength between the carrier layer and the bulk layer. In that case, the HDPE may have a share of at least 70 weight-%, preferably of at least 72.5 weight-% and even more preferably of at least 75 weight-% of the total weight of that individual bulk layer. It is also possible for the HDPE content to amount to at least 96 weight-% or even 100 weight-%.

The HDPE content may on the other hand preferably not exceed 92 weight-%, may more preferably not exceed 90 weight-%, and may particularly preferably not exceed 88 weight-% of the total weight of that individual bulk layer.

The LLDPE content of that individual bulk layer may preferably have a share of at least 15 weight-%, more preferably of at least 16 weight-%, and particularly preferably of at least 18 weight-%. The LLDPE content of that individual bulk layer may preferably not exceed 26 weight-%, may more preferably not exceed 24 weight %, and may particularly preferably not exceed 22 weight-%. The sum of percentages of HDPE and LLDPE of that individual bulk layer cannot exceed 100%, but can fall slightly short of 100%, if further components contribute to the formation of the bulk layer.

If a bulk layer is laminated to the deposition layer, this bulk layer may contain a printing layer or in regular printing or in reverse printing, so that in the latter case the bulk layer itself protects the printing from outside influences.

A bulk layer may alternatively be formed of HDPE alone.

If a vinyl alcohol barrier layer is present in the multi-layer film, it is preferably present on the side of a bulk layer bonded to the carrier layer facing away from the barrier film. In order to create sufficient bonding strength between the bulk layer and the vinyl alcohol barrier layer, a tie layer may be arranged between the bulk layer and the vinyl alcohol barrier layer.

The tie layer may preferably be a blend of LLDPE and an ethylene-based maleic anhydride-grafted polymer, although, however, other tie layer materials may be used as well. The grafted polymer is preferably polyethylene, particularly preferably LLDPE.

The LLDPE-content, referring to the ungrafted LLDPE, within the tie layer may preferably at least be 65 weight-%, more preferably at least be 67.5 weight-%, and particularly preferably at least be 70 weight-%. The LLDPE-content, in order not to compromise the enhancement of the bonding strength brought forward by the ethylene-based maleic anhydride-grafted polymer, may on the other hand preferably not exceed 90 weight-%, may more preferably not exceed 87.5 weight-%, and may particularly preferably not exceed 85 weight-%.

With inevitable impurities being neglected, the ethylene-based maleic anhydride-grafted polymer forms the remaining component to supplement the content of ungrafted LLDPE to a full 100 weight-% of the tie layer.

To the side of the vinyl alcohol barrier layer facing away from the bulk layer another tie layer may be applied, in order to bond further layers to the vinyl alcohol barrier layer. The tie layer on the side of the vinyl alcohol barrier layer facing away from the bulk layer and from the barrier film preferably corresponds to the first tie layer on the side facing towards the multilayer and carrier layer or at least does not deviate by composition from that the first tie layer and more than 5 percentage points of each of ungrafted LLDPE and ethylene-based maleic anhydride-grafted polymer.

The ethylene-based maleic anhydride-grafted polymer within the tie layers preferably is a maleic anhydride-grafted LLDPE.

To that second tie layer on the side of the vinyl alcohol barrier layer facing away from the barrier film and from the first bulk layer, a second bulk layer and/or a sealing layer may be bonded, for example by coextrusion or by lamination, and arranged.

In case a second bulk layer is bonded to the vinyl alcohol barrier layer through the second tie layer, the second bulk layer preferably corresponds to the first bulk layer in composition and thickness.

In case the sealing layer is bonded to the vinyl alcohol barrier layer or possibly also directly to the bulk layer described above, the sealing layer may as a main component comprise a bimodal terpolymer linear low density polyethylene. This bimodal terpolymer LLDPE preferably is blended with LDPE.

The content of bimodal terpolymer LLDPE within the sealing layer polymer preferably is at least 60 weight-%, more preferably at least 65 weight-%. It does on the other hand preferably not exceed 88 weight-%, more preferably not exceed 76 weight-%.

The LDPE-content within the sealing layer is preferably not less than 8.5 weight-%, more preferably not less than 8.8 weight-%, and particularly preferably not less than 9.0 weight-%. The content of LDPE does on the other hand preferably not exceed 11.5 weight-%, more preferably not exceed 11.1 weight-%, and particularly preferably not exceed 10.7 weight-%.

The sealing layer may further contain an ethylene-based plastomer, which can preferably be selected from ethylene/1-octene or from the 1-octene family. The ethylene-based plastomer content within the sealing layer preferably is at least 15 weight-%, more preferably at least 15.5 weight-%, and particularly preferably at least 15.9 weight-%. On the other hand, the ethylene-based plastomer content within the sealing layer preferably does not exceed 23 weight-%, more preferably not exceed 21.5 weight-%, and particularly preferably not exceed 20 weight-%.

The sealing layer, being by nature an outermost layer of the multi-layer film, may additionally comprise functional agents, for example an antiblocking agent and/or a friction-reducing slip-enhancing agent. The antiblocking agent preferably is the same as in the carrier layer. The slip-enhancing agent preferably is a non-migratory slip additive compounded in polyethylene.

The content of the antiblocking agent within the sealing layer polymer preferably ranges between 2.3 and 2.8 weight-% in one embodiment or between 0.9 and 1.1 weight-% in another embodiment. Likewise, the content of the slip-enhancing agent within the sealing layer polymer preferably ranges between 1.3 and 1.6 weight % in the one embodiment and between 0.9 and 1.1 weight-% in the other embodiment.

As explained above, a further layer of the at least one additional layer, in particular bulk layer, is bonded to the deposition layer so that the deposition layer is located between the polymer carrier layer and the further layer. A tie layer may be present between the deposition layer and the further layer, depending on the material used to form the further layer.

In order to be able to form a closed packaging out of the multi-layer film, the at least one additional layer comprises a sealable layer forming an exposed surface of the multi-layer film.

The present invention further relates to a packaging, in particular flexible packaging, comprising the multi-layer film as described and refined above. The packaging encloses a packaging volume. The packaging volume is suitable and intended to accommodate a then-packaged object.

The packaging may be any sort of flexible packaging. A possible flexible packaging may be a stick pack, a pouch, in particular a four-side seal pouch or a three-side seal pouch, a standing pouch, a flow-pack and so forth.

The barrier properties of the multi-layer films described above, in particular owed to the barrier properties of the barrier film with the deposition layer, allows to pack chemically aggressive products like coffee, dried soups, and even products that are filled into the packaging in a hot state, like for example prepared convenience foodstuff.

Preferably 90 weight-% of the multi-layer film consist of one material group, particularly preferably polymers that have ethylene as a monomer, so that the multi-layer film after use can easily be recycled, preferably in one single recycling stream.

The use of designations like “first”, “second”, “third” and so forth, in the present application only serves to separate similar or otherwise identically designated features. It does not serve to indicate a certain order. Consequently, the subject-matter of the present invention may contain a first and a third feature of the same or a similar kind, but not a second feature. It may as well contain only a first feature without a second, third or further basically optional feature of the same or a similar kind.

Based on the previous description of the invention viewed from a different angle, the subject-matters as listed in the following are of particular interest to the invention, starting with Subject-Matter A:
A. A barrier film (12; 112), wherein the barrier film (12; 112) comprises a polymer carrier layer (14; 114), wherein the carrier layer (14; 114) bears on at least one of its surfaces (14a; 114a) a deposited deposition layer (16; 116) of a metal-based material, wherein the polymer of the carrier layer (14; 114) contains a linear ethylene-based polymer,
   characterized in that the polymer of the carrier layer (14; 114) comprises a blend of low density polyethylene, a linear ethylene-based polymer and at least one receptor component selected from
i) a terpolymer of ethylene, acrylic acid, and acrylate, and
ii) an ethylene-based alpha-copolymer grafted with a polar group.
B. The barrier film (12; 112) according to Subject-Matter A, characterized in that the metal-based material of the deposition layer (16; 116) comprises at least one of a metal and a metal-oxide.
C. The barrier film (12; 112) according to Subject-Matter A or B, characterized in that the linear ethylene-based polymer comprises at least one of a linear low density polyethylene and a linear ethylene-octene copolymer.
D. The barrier film (12; 112) according to one of the preceding subject-matters, characterized in that the linear ethylene-based polymer comprises a metallocene linear ethylene-based polymer or consists of a metallocene linear ethylene-based polymer.
E. The barrier film (12; 112) according to one of the preceding subject-matters,
characterized in that
i) the weight proportion of the receptor component in the total weight of the polymer carrier layer (14; 114) ranges between 26 to 34 weight-%,
ii) the weight proportion of the linear ethylene-based polymer in the total weight of the polymer carrier layer (14; 114) ranges between 44 to 46 weight-%, and
iii) the weight proportion of the low density polyethylene in the total weight of the polymer carrier layer (14; 114) ranges between 15 to 21 weight-%,
with the polymer of the polymer carrier layer (14; 114) representing 100 weight-%.
F. The barrier film (12; 112) according to one of the preceding subject-matters,
characterized in that the polymer of the carrier layer (14; 114) comprises an antiblocking agent.
G. The barrier film (12; 112) according to Subject-matter F,
characterized in that the antiblocking agent comprises or consists of a mineral silica compound in polyethylene.
H. The barrier film (12; 112) according to Subject-Matter F or G,
characterized in that the weight proportion of the antiblocking agent in the total weight of the polymer carrier layer (14; 114) ranges between 1.4 to 2.6 weight-%.
I. The barrier film (12; 112) according to one of the preceding subject-matters,
characterized in that the polymer carrier layer (14; 114) is a blown film or is part of a blown multi-layer film.

J. The barrier film (12; 112) according to one of the preceding subject-matters,
characterized in that the polymer of the carrier layer (14; 114) consists of a blend of
i) low density polyethylene;
ii) a linear ethylene-based polymer;
iii) a terpolymer of ethylene, acrylic acid, and acrylate; and
iv) an antiblocking agent.

K—A multi-layer film (10; 110) comprising the barrier film (12; 112) of one of the preceding subject-matters and at least one additional layer selected from a layer group containing at least the following layer types:
a) a bulk layer (18, 22; 118, 122, 134),
b) a sealable layer (20; 120),
c) an oxygen barrier layer (128),
d) a water vapor barrier layer (134), and
e) a tie layer (130, 132),
wherein the multi-layer film (10; 110) may comprise more than one layer of the same layer type.
L. The multi-layer film (10; 110) according to Subject-Matter L, characterized in that a further layer (22, 24, 26; 122, 124, 126) of the at least one additional layer is bonded to the deposition layer (16; 116) so that the deposition layer (16; 116) is located between the polymer carrier layer (14; 114) and the further layer (22, 24, 26; 122, 124, 126).
M. The multi-layer film (10; 110) according to Subject-Matter L or M, characterized in that the at least one additional layer comprises a sealable layer (20; 120)) forming an exposed surface (10b; 110b) of the multi-layer film (10; 110).
N. A packaging (80) comprising the multi-layer film (10; 110) according to one of subject-matters L to N, wherein the packaging (80) encloses a packaging volume (82), wherein the packaging volume (2) is suitable and intended to accommodate an object (86).

### BRIEF DESCRIPTION OF THE DRAWINGS

Reference will be made to embodiments of the invention, examples of which may be illustrated in accompanying figures. These figures are intended to be illustrative, not limiting. Although the invention is generally described in context of these embodiments, it should be understood that it is not intended to limit the scope of the invention to these particular embodiments.

FIG. 1 shows a laminate in accordance with an embodiment of the invention.

FIG. 2 shows a schematic cross-sectional view through a second embodiment of a multi-layer film according to the present invention containing the barrier film described above,

FIG. 3 shows a schematic cross-sectional view through a third embodiment of a multi-layer film according to the present invention containing the barrier film described above, and

FIG. 4 shows a schematic example of a flexible packaging formed out of the exemplary multi-layer films of FIG. 2 or 3.

### DETAILED DESCRIPTION OF THE INVENTION

The present invention provides polyethylene films with superior oxygen and moisture barrier properties while retaining other essential properties such as heat sealability, machine-ability on packaging lines, product protection etc. Laminates made using the film of the invention provides barrier properties without incorporating a separate barrier layer, whilst still maintaining its heat-sealing capabilities of the sealing side and its heat-resistant properties at the printed side. This elimination of a separate metallic or non-metallic barrier layer typically used in the laminates makes the newly designed laminates lower in thickness & weight thereby reducing overall plastic usage, cost as well as makes it recyclable when the films used are from same polymer family (mono material).

In one aspect, the present invention provides a film composition comprising acid copolymer in a range of 1 to 10%, metallocene LLDPE in a range of 5 to 15%, low density polyethylene (LDPE) in a range of 5 to 10%, anti-block masterbatch in the range of 0.5 to 1%, high density polyethylene (HDPE) in a range of 20 to 50%, plastomer in a range of 5 to 30% and slip additive in a range of 0.5 to 1%.

In an embodiment, the film composition further comprises medium density polyethylene (MDPE) in a range of 5 to 15%, Tie layer in a range of 1 to 10%, Ethylene vinyl alcohol (EVOH, with a mole % ethylene content in the range of 27-40) to the maximum content of 7%.

The acid copolymer of the film composition is selected from terpolymers of ethylene, methacrylic acid and acrylate or acid modified olefine copolymer. The metallocene LLDPE comprises of metallocene ethylene-octene copolymer. The LDPE comprises polyethylene having a minimum density of 0.910. The HDPE comprises polyethylene having a minimum density of 0.941. The tie layer comprises of maleic anhydride modified linear low-density polyethylene adhesive resin. The plastomer is selected from ethylene 1-octene or 1-octene. The slip additives are selected from erucamide, oleamide and/or stearamide compounded in polyethylene or modified non migratory polymer additives.

In an embodiment, the present invention provides a film formed using the composition as mentioned hereinabove, wherein the film is further metallized with optical density equal to or greater than 2.2. In this regard, the film is metallized using a vacuum metallization process. During the metallization process, vapors of aluminum are deposited on the film of the invention using a vacuum metallizer machine. The aluminum metallization on the film of the present invention further improves the barrier level. In another embodiment a process of transparent metallization of Aluminium oxide (AlOx) coating through vacuum deposition process also improves the barrier property of the said film and allows a see-through feature. Accordingly, the film is embedded with barrier properties within the sealant layer.

In another embodiment, to further improve the barrier properties of the film a water-based barrier coating can also be deposited/coated on either side of said film before metallization.

Alternatively, instead of use of EVOH as a resin in the film composition for improving the barrier properties, a coating of modified EVOH or PVOH coatings may be applied in an off-line process.

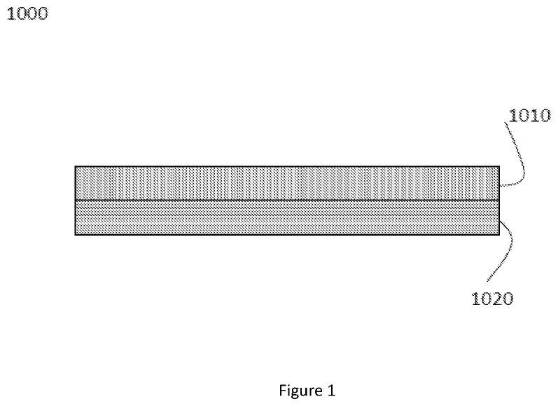

In another aspect, the present invention provides a laminate. FIG. 1 shows a laminate 1000 in accordance with an embodiment of the invention. The laminate comprises a first film 1010; and a second film 1020 bonded with the first film. The first film is a preferably a printable film selected from family of PET, BOPP, BOPE, MDO PE, BON etc. The film can be reversed or surface printed. The second film is a film of the invention discussed hereinabove, wherein the film is embedded with barrier properties within the sealant layer. The present invention thus eliminates the need of separate barrier film. In an embodiment, the second film comprises the film composition of acid copolymer in a range of 1 to 10%, metallocene Linear low density polyethylene (LLDPE) in a range of 5 to 15%, low density polyethylene (LDPE) in a range of 5 to 10%, anti-block masterbatch in the range of 0.5 to 1%, high density polyethylene (HDPE) in a range of 20 to 50%, plastomer in a range of 5 to 30% and slip additive in a range of 0.5 to 1%. Further, when the laminate of the invention is designed with a PE film (either a MDO PE or BOPE or Non-oriented PE, etc.) as the first film and PE film of the invention as the second film, the final laminate is then >90% monomaterial PE & hence is recyclable with a recyclability level of >90%.

In an embodiment, the film composition of the second film in the laminate further comprises bonding polymer in a range of 1 to 10%, medium density polyethylene (MDPE) in a range of 5 to 15%, and Ethylene vinyl alcohol (EVOH) in the range of 0.1 to 7%, wherein ethylene content in EVOH is in the range of 27-40%.

The acid copolymer used in the film composition of the laminate is selected from terpolymers of ethylene, methacrylic acid and acrylate or acid modified olefine copolymer. The acid copolymer improves the bonding of metallization to the base film and provides optimum bonding. The metallocene LLDPE comprises of metallocene ethylene-octene copolymer and imparts mechanical strength to the film. The LDPE comprises polyethylene having a minimum density of 0.910 and plays an important role in providing elongation to the film. Elongation is crucial for optimum machinability. The HDPE comprises polyethylene having a minimum density of 0.941 and aids in improving the stiffness and barrier property of the film. The tie layer comprises of maleic anhydride modified linear low-density polyethylene adhesive resin. The plastomer is selected from ethylene 1-octene or 1-octene and helps in reducing the sealing temperature of the composition i.e. gives optimum seal range and aids in easy processability. The slip additives are selected from erucamide, oleamide and/or stearamide compounded in polyethylene or modified non migratory polymer additives and assists in maintaining the coefficient of friction. Similarly, the tie layer imparts improved bond between EVOH and the film composition. The MDPE provides rigidity and maintains the balance between density and mechanical strength. EVOH imparts barrier properties, more particularly oxygen barrier properties.

The laminate is suitable to form packages with barrier properties equivalent to or superior to laminates in which barrier films like acrylic coated Bi-oriented Polypropylene (BOPP), metallized BOPP, AlOx coated BOPP, SiOx coated BOPP, metallized cast polypropylene (CPP) are used.

In another embodiment of the invention, the laminate produced using the film of the present invention may additionally comprise layers selected from, but not limited to, a print/ink layer, adhesive layer, primer layer, extrusion lamination layer, extrusion coating layer, (matt) lacquer layer etc. Further depending on functional requirements of the product to be packed, the laminate produced using the film of the invention may contain additional barrier, print or sealant layers making the final laminate composite a 3ply, 4ply, 5ply laminate.

In another aspect, the invention also relates to a process for manufacturing a film of the present invention using blown film extrusion process preferably comprising the steps of melting the polymer resins in an extruder; extruding the polymer resin melt via a die head and injecting air to radially inflate the polymer into a hot thin tube as per the desired film thickness and width; cooling the hot thin tube constantly while moving upward by the high-speed air ring mounted on the top of die till passed via nip rolls; flattening the cooled tube reaching the nip rolls to form the collapsed tube or lay-flat film; transferring the lay-flat film to the extrusion tower via rollers; winding up the lay-flat film onto the reels.

In a preferred embodiment of the process, an exchange of air inside the bubble takes place when the lay-flat film is on its way to the extrusion tower on the higher output lines. This is known as Internal Bubble Cooling or IBC. Thus, the process involves critical control on Internal Bubble Cooling (IBC) and OBC (Outer bubble cooling) temperature settings, typically maintained between 10-30° C. for both IBC and OBC as well as maintaining the blow-up ratio equal to or more than 2.

### EXAMPLES

The following experimental examples are illustrative of the invention but not limitative of the scope thereof:

### Example 1

| Film components | % |
|---|---|
| Ter polymer of Ethylene Meth acrylic acid and acrylate | 5.4 |
| Ethylene 1-Octene plastomer | 6.6 |
| Metallocene ethylene-Octenecopolymer | 11.0 |
| Low density polyethylene resin | 3.96 |
| Mineral silica antiblock compounded in polyethylene | 0.44 |
| High density polyethylene | 44.6 |
| Bimodal terpolymer linear low density polyethylene | 24.5 |
| Low density polyethylene | 2.8 |
| Mineral silica antiblock compounded in polyethylene | 0.35 |
| Non migratory slip additive compounded in polyethylene | 0.35 |

The film produced using components of Example 1 was further metallized using a vacuum metallization process. During the metallization process, vapors of aluminum or Aluminium Oxide (ALOx) are deposited on the film layer using a vacuum metallizer machine. The layer of aluminum on the film of example 1 further improves the barrier properties.

The barrier values were checked pre & post metallization of film of Example 1 of the present invention and the results obtained were as follows:

Pre-metallisation values Measured at

| 23° C., 0-50% RH | 38° C., 90% RH |
|---|---|
| Achieved Oxygen transmission | Achieved Moisture Vapor |
| Rate (OTR) - ASTM D3985 | Transmission Rate (MVTR) - |
| | ASTM F1249 |
| <400 | <3 |

Post metallisation values Measured at

| | |
|---|---|
| 23° C., 0-50% RH | 38° C., 90% RH |
| Achieved Oxygen transmission | Achieved Moisture Vapor |
| Rate (OTR) | Transmission Rate (MVTR) |
| <20 | <0.5 |
| Interlayer bond strength (metal to | Minimum 200 Gms/15 mm |
| PE) - Tested as per AIMCAL - TP - | |
| 105-92 | |

As can be seen in the results achieved, the metallized film exhibits excellent barrier values.

Further, as can be seen in the results achieved, the metallized film further exhibits excellent interlayer bond strength between metal and base PE film which enables highest quality packaging laminates.

The film produced using components of Example 1 in non-metallized version, when laminated to a standard Polyethylene Terephthalate (PET) or Biaxially oriented polypropylene (BOPP) film or Biaxially oriented Nylon (BOPA) or PE films (MDO or BOPE or non-oriented PE etc.) is suitable for packing products which need medium barrier levels such as cereals, cookies, biscuits etc. The resultant laminate provides barrier levels equivalent to laminates in which barrier films like metallized BOPP, metallized cast polypropylene (CPP), Metallized PET layers are separately incorporated.

This film produced using components of Example 1 in metallized version, when laminated to a standard Polyethylene Terephthalate (PET) or Bi-axially oriented polypropylene (BOPP), Biaxially oriented Nylon (BOPA) or PE films (MDO or BOPE or non-oriented PE etc.) provides a laminate which is suitable for packing products which need high barrier levels such as shampoos, snacks, fabric conditioners, etc. The resultant laminate provides barrier equivalent to laminates in which high barrier metallized BOPP, metallized PET layers are used specifically for barrier.

### Example 2

| Film components | % |
|---|---|
| Terpolymer of ethylene, methacrylic acid and acrylate | 5.4 |
| Metallocene ethylene-Octene copolymer | 8.64 |
| Low density polyethylene resin | 6.15 |
| Mineral silica antiblock compounded in polyethylene | 0.7425 |
| High density polyethylene | 36 |
| Medium density ethylene 1-octene copolymer | 10.5 |
| Maleic anhydride modified linear low density polyethylene | 3.5 |
| adhesive resin | |
| 29 mol % ethylene vinylalcohol copolymer | 6.5 |
| Bimodal terpolymer linear low density polyethylene | 17.085 |
| Ethylene 1-Octene plastomer | 5.1 |
| Non migratory slip additive compounded in polyethylene | 0.3825 |

The film produced using components of Example 2 was metallized using a vacuum metallization process. During the metallization process, vapors of aluminum with minimum optical density of 2.2 or Aluminum oxide (ALOx) are deposited on the polyethylene layer using a vacuum metallizer machine. The layer of aluminum on the film of Example 2 further improves the barrier level. The barrier values were checked pre & post metallization of the film of Example 2 and the results noted were as follows:

Pre-metallisation Measured at

| 23° C., 0-50% RH | 38° C., 90% RH |
|---|---|
| Achieved Oxygen Transmission | Achieved Moisture Vapor |
| Rate (OTR)- ASTM D3985 | Transmission Rate (MVTR)- |
| | ASTM F1249 |
| <1 | <3 |

Post metallisation Measured at

| | |
|---|---|
| 23° C., 0-50% RH | 38° C., 90% RH |
| Achieved Oxygen Transmission | Achieved Moisture Vapor |
| Rate (OTR) | Transmission Rate (MVTR) |
| <0.5 | <0.5 |
| Interlayer bond strength (metal to | Minimum 200 Gms/15 mm |
| PE) - Tested as per AIMCAL - TP - | |
| 105-92 | |

Further, as can be seen in the results achieved, the metallized film further exhibits excellent interlayer bond strength between metal and base PE film which enables highest quality packaging laminates.

This film produced using components of Example 2 in non-metallized version when laminated to a standard Polyethylene Terephthalate (PET) or Bi-axially oriented polypropylene (BOPP) or Biaxially oriented Nylon (BOPA) or PE films (MDO or BOPE or non-oriented PE etc.) provides a laminate which is suitable for packaging products which needs high barrier levels such as flavored cereals, extruded snacks, cookies, salad dressing, meat & cheese etc. The resultant laminate provides barrier levels equivalent to laminates in which barrier films like metallized PET (>=2.2 optical density) or transparent barrier films or Metallized BOPP, Aluminium Foil or coated films are used.

The film produced using components of Example 2 in metallized version when laminated to a standard Polyethylene Terephthalate (PET) or Bi-axially oriented polypropylene (BOPP) film or Biaxially oriented Nylon (BOPA) or PE films (MDO or BOPE or non-oriented PE etc.) provides a laminate which is suitable for packaging products requiring very/ultra-high barrier levels such as Coffee, Ketchup, milk powders, malt beverages, infant formula etc. The resultant laminate provides barrier equivalent to laminates in which high barrier metallized BOPP, aluminum foil layers are used specifically for barrier.

Example 3—The film produced using components in example 1 was further applied/coated with a layer of PVOH (poly vinyl alcohol) coating or polyvinyl alcohol coating modified with nano particles in an offline process using standard coating machines available in the industry. The coating weight of PVOH was between 0.5-2 grams/sq. meter. The resultant film with PVOH coating was tested for barrier values, with and without metallization and results achieved are mentioned as follows,

Pre-metallisation Measured at

| 23° C., 0-50% RH | 38° C., 90% RH |
|---|---|
| Achieved Oxygen Transmission Rate | Achieved Moisture Vapor |
| (OTR)- ASTM D3985 | Transmission Rate (MVTR)- |
| | ASTM F1249 |
| <1 | <3 |

Post metallisation Measured at

| | |
|---|---|
| 23° C., 0-50% RH | 38° C., 90% RH |
| Achieved Oxygen Transmission Rate | Achieved Moisture Vapor |
| (OTR) | Transmission Rate (MVTR) |
| <0.5 | <0.5 |
| Interlayer bond strength (metal to PE) - | Minimum 200 Gms/15 mm |
| Tested as per AIMCAL - TP - 105-92 | |

For consumer convenience of easy tear ability on finished packs, a minimum of 10% COC (Cyclic Olefin Copolymer) can also be added to the film compositions as provided in the Examples.

Various laminates were prepared using the films obtained in examples 1-3 and the OTR and MVTR values were obtained as follows:

| | | OTR value | MVTR value |
|---|---|---|---|
| | | 23° C., | 38° C., |
| Sr. | | 0-50% RH | 90% RH |
| No. | Laminate | ASTM D3985 | ASTM F1249 |
| 1 | 18 Mic BOPP | <400 | <1.5 |
| | Film/Adhesive/50 Mic Film | | |
| | produced using components | | |
| | of Example 1 (Pre- | | |
| | metallisation) | | |
| 2 | 18 Mic BOPP | <20 | <0.5 |
| | Film/Adhesive/50 Mic Film | | |
| | produced using components | | |
| | of Example 1 (Post- | | |
| | metallisation) | | |
| 3 | 18 Mic BOPP | <1 | <1.5 |
| | Film/Adhesive/50 Mic Film | | |
| | produced using components | | |
| | of Example 2 (Pre- | | |
| | metallisation) | | |
| 4 | 18 Mic BOPP | <0.5 | <0.5 |
| | Film/Adhesive/50 Mic Film | | |
| | produced using components | | |
| | of Example 2 (Post- | | |
| | metallisation) | | |
| 5 | 18 Mic BOPP | <2 | <1.5 |
| | Film/Adhesive/50 Mic Film | | |
| | produced using components | | |
| | of Example 3 (Pre- | | |
| | metallisation) | | |
| 6 | 18 Mic BOPP | <1 | <0.5 |
| | Film/Adhesive/50 Mic Film | | |
| | produced using components | | |
| | of Example 3 (Post- | | |
| | metallisation) | | |

Advantageously, the present invention provides a film composition with excellent barrier properties and a laminate comprising the film, wherein the laminate also exhibits excellent barrier properties without the requirement for a separate barrier layer. This laminate in combination with BOPP, PET, BOPA and PE films (MDO or BOPE or non-oriented PE etc.) can be used in packaging of wide range of products. Moreover, the present invention provides a laminate which is highly economic since the elimination of a separate metallic/barrier layer greatly reduces the cost. Advantageously, the film of the present invention exhibits much superior barrier values compared to standard polyethylene films or even to a laminate having polyethylene layer along with a separate barrier layer and eliminates the need of a separate barrier film. This film of the present invention when laminated to a standard polyethylene terephthalate (PET) or biaxially oriented polypropylene (BOPP) film or Biaxially Oriented Nylon film (BOPA) or PE films (MDO or BOPE or non-oriented PE etc.) provides a laminate which is suitable to pack wide range of products which require low to high barrier levels. The resultant laminate provides barrier levels equivalent to laminates in which barrier films like BOPP, metallized BOPP, metallized cast polypropylene (CPP), Metallized PET, Al Foil layers are used specifically. This means that a two-ply laminate manufactured using the inventive film provides barrier levels comparable to the barrier properties of a conventional three-ply laminate. This reduction of one layer of barrier film in laminate allows better yield, plastic source reduction and saves cost. Further, when the laminate is designed with a PE film (either a MDO PE or BOPE or Non-oriented PE etc.) as the first film and PE film of the invention as the second film, the final laminate is then >90% monomaterial PE & hence is recyclable with a recyclability level of >90%.

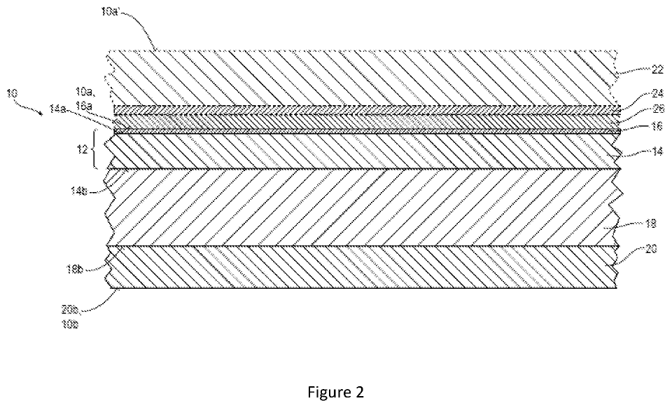

The drawings of FIGS. 2 to 4 are not true to scale.

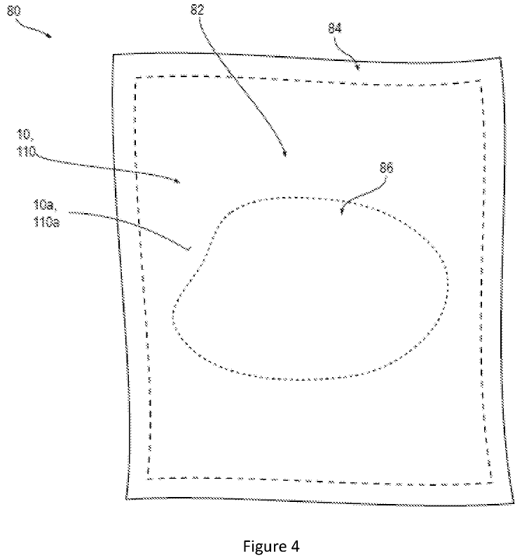

In FIG. 2 a second embodiment of a multi-layer film according to the present invention is generally designated by reference numeral 10. The multi-layer film 10 comprises a barrier film 12 formed out of a carrier layer 14 having a deposition layer 16 deposited on one of its outermost surfaces. The deposition layer 16 is deposited, for example by physical vapor deposition (PVD) to the outermost surface 14a of the carrier layer 14 which faces to the outside, i. e. away from a packaged product, in a packaging (see packaging 80 in FIG. 4) formed out of multi-layer film 10.

The carrier layer 14 in the depicted example is made of a polymer blend containing 5.9 to 7.3 weight-%, with regard to the overall weight of multi-layer film 10, of a terpolymer of ethylene, methacrylic acid and acrylate. The blend of the polymer of carrier layer 14 further contains 9.9 to 12.1 weight-% of a metallocene linear low density polyethylene, contains 3.6 to 4.4 weight-% of LDPE and further contains 0.4 to 0.48 weight-% of a mineral silica antiblocking agent compounded in polyethylene.

The carrier layer 14 has a proportion of approximately 22 weight-% of the total weight of multi-layer film 10 in an embodiment of multi-layer film 10 where the surface 16a of the deposition layer 16 is an exposed outermost layer 10a of the multi-layer film 10.

The deposition layer 16 in the depicted example is a physically vapor deposited aluminum layer with an optical density of 2.8 or higher.

Although the carrier layer 14 could possibly bear two deposition layers, one on either surface 14a and 14b, preferably the carrier layer 14 has only one deposition layer 16 deposited on one of its surfaces, here: surface 14a.

On the surface 14b, which faces towards packaging volume and hence towards a packaged product of a flexible packaging formed by multi-layer film 10 or by contribution of multi-layer film 10, a first bulk layer 18 is arranged. This first bulk layer 18 in the depicted example is formed by a blend of HDPE with a share of between 36 to 44 weight-% and linear low density polyethylene with a share of between 9 to 11 weight-% of the total weight of the multi-layer film 10. The bulk layer 18 forms approximately 50 weight-% of the entire weight of multi-layer film 10.

On the surface 18b of the bulk layer 18 the sealing layer 20 is arranged. The sealing layer 20 is formed from a blend of a bimodal terpolymer LDPE, which has a weight share of between 21.6 to 24.4 weight-% of the entire multi-layer film weight, of LDPE with a component proportion in the range of 2.5 to 3.0 weight-%, of a mineral silica antiblocking agent compounded in polyethylene with a component proportion in the range of 0.63 to 0.77 weight-%, and of a non-migratory slip additive compounded in polyethylene having a component proportion in the range of 0.37 to 0.46 weight-% of the entire multi-layer film weight. The sealing layer 20 in the depicted example has a weight proportion of approximately 28 weight-% of the multi-layer film weight.

This is a basic embodiment of a possible multi-layer film 10 according to the present invention. The outermost surface of the deposition layer 16a forms an outermost surface 10a of the multi-layer film 10. The exposed surface 20b of the sealing layer forms the opposite outermost surface 10b of the multi-layer film 10.

Multi-layer film 10, as it has been described so far, is preferably a multi-layer coextruded film, particularly preferably a multi-layer coextruded blown film.

Optionally, multi-layer film 10 can have a second bulk layer 22, for example formed by HDPE, optionally by machine direction oriented HDPE, which is reverse printed with a printing layer 24 and which is laminated to the deposition layer 16 by a suitable tie layer 26. In case the optional layers 22, 24, and 26 are present, the exposed surface 22a of the second bulk layer 22 forms an exposed outer surface 10a′ of the multi-layer film 10, instead of surface 16a, which will then be an inner inter-layer surface of the multi-layer film 10.

Extending the multi-layer film 10 by adding the optional further layers 22, 24 and 26, which are shown in dashed lines in FIG. 2, alters the weight percentages given above for the individual layers and their composition components related to the multi-layer film 10 without the optional layers.

Multi-layer film 10 without the optional layers achieves an oxygen transmission rate measured according to the standards given above of less than 20 cm³/(d·m²) and a water vapor transmission rate measured according to the standards given above of less than 0.5 g/(d·m²).

As a comparison value, the same multi-layer film 10, without the deposition layer 16, has 20 times the oxygen transmission rate, and has six times the water vapor trans-mission rate of the multi-layer film 10 with the deposition layer. This significant decrease in transmission rates is owed to the terpolymer of ethylene, methacrylic acid, and acrylate in the blend of carrier layer 14. This terpolymer increases the bonding strength of the bond between the deposition layer 16 and the carrier layer 14, and in the wake of this increased bonding strength the barrier properties are tremendously increased. An increase of barrier properties corresponds to a decrease of transmission rates.

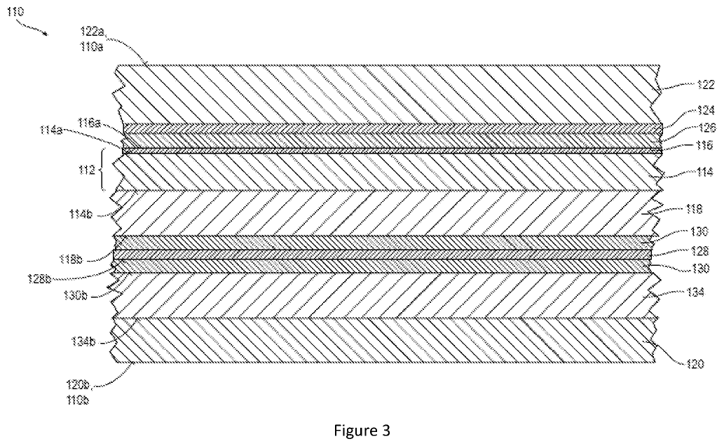

FIG. 3 shows a third embodiment of a layer 110 according to the present invention. This layer 110 also has a barrier film 112 formed of a carrier layer 114 and a deposition layer 116 deposited on the later outer surface 114a of the carrier layer 114.

Components and portions of components of the third embodiment shown in FIG. 3 that are equal in structure or function to components and portions of components, respectively, of the second embodiment shown in FIG. 2 are labeled by the same reference numerals as in the second embodiment, but increased by the number 100. The third embodiment will subsequently be explained in detail only insofar as it deviates from the second embodiment. For components and portions of components of the third embodiment that are not explicitly explained below, reference is made to the specification of the second embodiment which applies also to the third embodiment.

The third embodiment has additional barrier layers and achieves therefore even better barrier properties, i. e. even lower oxygen and water vapor transmission rates.

Multi-layer film 110 contains the second bulk layer 122, the reverse printed printing layer 124, and the tie layer 126 to bond the second bulk layer 122 together with the printing layer 124 to the deposition layer 116.

In contrast to the second embodiment, the first bulk layer 118 of the third embodiment is formed only of HDPE.

The third embodiment contains an oxygen barrier layer 128 which in the depicted example is formed of ethylene vinyl alcohol copolymer (EVOH). It is bonded to the first bulk layer 118 through a tie layer 130, which is formed of a blend of regular, ungrafted LLDPE and a maleic anhydride-grafted polyethylene, in particular maleic anhydride-grafted LLDPE. It contains by weight about 3.3 to 3.6 times more ungrafted LLDPE than maleic anhydride-grafted polyethylene.

On the surface 128b facing away from the barrier film 112 another tie layer 132 is applied to the oxygen barrier layer 128, in order to bond a further, in this case a third bulk layer 134 to the oxygen barrier layer 128. Preferably, this further bulk layer 134 is identical to the first bulk layer 118. The presence of two bulk layers 118 and 134 each made of pure HDPE further increases the barrier properties of multi-layer film 110.

On the surface 134b facing away from the oxygen barrier layer 128 the sealing layer 120 known as sealing layer 20 from the second embodiment is bonded to the further bulk layer 134.

Multi-layer film 110 of the third embodiment has an oxygen transmission rate, measured according to the standards mentioned above, of less than 0.5 cm³/(d·m²) and a water vapor transmission rate measured according to the standards given above of also less than 0.5 g/(d·m²).

Again as a comparison value, the same multi-layer film 110, without the deposition layer 116, has two times the oxygen transmission rate, and has six times the water vapor transmission rate of the multi-layer film 110 with the deposition layer. This significant decrease in transmission rates is again owed to the terpolymer of ethylene, methacrylic acid, and acrylate in the blend of carrier layer 14. The terpolymer increases the bonding strength of the bond between the deposition layer 116 and the carrier layer 114, and in the wake of this increased bonding strength the barrier properties are tremendously increased.

Multi-layer film 110 is also preferably a multi-layer coextruded film 110, particularly preferably a multi-layer coextruded blown film 110.

In FIG. 4 a possible flexible packaging formed out of multi-layer film 10 of FIG. 2 or multi-layer film 110 of FIG. 3 is shown. The flexible packaging is a four-side-seal pouch 80 which can be used to pack objects, in particular food and similar critical goods.

The front side of the pouch 80, on which the viewer of FIG. 4 looks, and the back side of the pouch 80 are made of identical rectangular blanks of multi-layer film 10 or 110.

Pouch 80 has a central packaging volume 82 which is sealingly surrounded by a sealed area 84, in which the sealing layers 20 or 120, respectively, are arranged with their exposed surfaces 20b or 120b, respectively, in contact with one another and are then heat-sealed to hermetically enclose the packaging volume 82. Consequently, an object 86 can be safely accommodated in the packaging volume 82 over a comparably long time without losing quality.

While the present invention has been described with respect to certain embodiments, it will be apparent to those skilled in the art that various changes and modification may be made without departing from the scope of the invention as defined in the following claims.

1. A film composition comprising acid copolymer in a range of 1 to 10%, metallocene Linear low-density polyethylene (LLDPE) in a range of 5 to 15%, low density polyethylene (LDPE) in a range of 5 to 10%, anti-block masterbatch in the range of 0.5 to 1%, high density polyethylene (HDPE) in a range of 20 to 50%, plastomer in a range of 5 to 30% and slip additive in a range of 0.5 to 1%.

2. The film composition as claimed in claim 1, further comprising bonding polymers in a range of 1 to 10%, medium density polyethylene (MDPE) in a range of 5 to 15% and Ethylene vinyl alcohol (EVOH) in the range of 0.1 to 7%, wherein ethylene content in EVOH is in the range of 27-40%.

3. The film composition as claimed in claim 1, wherein the acid copolymer is a terpolymer of ethylene, methacrylic acid and acrylate or acid modified olefine copolymer.

4. The film composition as claimed in claim 1, wherein the metallocene LLDPE comprises of metallocene ethylene-octene copolymer.

5. The film composition as claimed in claim 1, wherein the plastomer is selected from ethylene 1-octene or 1-octene and slip additives are selected from erucamide, oleamide and/or stearamide compounded in polyethylene or modified non migratory additives.

6. A film formed with the film composition as claimed in claim 1.

7. The film as claimed in claim 6, wherein the film is further coated with modified EVOH or PVOH coatings or PVOH coating with nano particles.

8. The film as claimed in claim 6, wherein the film is metallized or non-metallized.

9. A laminate, comprising:
a. a first film; and
b. a second film bonded with the first film, the second film comprising a film composition of acid copolymer in a range of 1 to 10%, metallocene Linear low density polyethylene (LLDPE) in a range of 5 to 15%, low density polyethylene (LDPE) in a range of 5 to 10%, anti-block masterbatch in the range of 0.5 to 1%, high density polyethylene (HDPE) in a range of 20 to 50%, plastomer in a range of 5 to 30% and slip additive in a range of 0.5 to 1%.

10. The laminate as claimed in claim 9, wherein the film composition of the second film further comprising bonding polymers in a range of 1 to 10%, medium density polyethylene (MDPE) in a range of 5 to 15%, and Ethylene vinyl alcohol (EVOH) in the range of 0.1 to 7%, wherein ethylene content in EVOH is in the range of 27-40%.

11. The laminate as claimed in claim 9, wherein the second film is coated with modified EVOH or PVOH coatings or PVOH coating with nano particles.

12. The laminate as claimed in claim 9, wherein the acid copolymer is a terpolymer of ethylene, methacrylic acid and acrylate or acid modified olefine copolymer.

13. The laminate as claimed in claim 9, wherein the metallocene LLDPE comprises of metallocene ethylene-octene copolymer.

14. The laminate as claimed in claim 9, wherein the plastomer is selected from ethylene 1-octene or 1-octene and slip additives are selected from erucamide, oleamide and/or stearamide compounded in polyethylene or modified non migratory additives.

15. The laminate as claimed in claim 9, wherein the second film is metallized or non-metallized.
